(19) United States
(12) Patent Application Publication
(10) Pub. No.: US 2025/0149979 A1
(43) Pub. Date: May 8, 2025

(54) POWER CONVERSION DEVICE AND CONTROL METHOD

(71) Applicant: Delta Electronics (Shanghai) CO., LTD., Shanghai (CN)

(72) Inventors: Qing JIANG, Shanghai (CN); Yongkai LIAO, Shanghai (CN); Wenqiang CAI, Shanghai (CN); Dong GUO, Shanghai (CN)

(73) Assignee: Delta Electronics (Shanghai) CO., LTD., Shanghai (CN)

(21) Appl. No.: 18/931,031

(22) Filed: Oct. 29, 2024

(30) Foreign Application Priority Data
Nov. 2, 2023 (CN) 2023114527298

(51) Int. Cl. H02M 1/44; H02J 50/10; H02J 50/70; H02M 1/00; H02M 3/335

(52) U.S. Cl. CPC H02M 1/44; H02J 50/10; H02J 50/70; H02M 1/0043; H02M 3/33569

(57) ABSTRACT

A power conversion device includes a DC-to-DC converter and a control unit, the control unit includes a phase-locked loop controller, and the DC-to-DC converter includes a primary side circuit, a secondary side circuit and a transformer. The transformer transfers energy between the primary side circuit and the secondary side circuit, the primary side circuit includes an inverter circuit, and the phase-locked loop controller outputs a first driving signal. The first driving signal is generated according to a phase jitter signal, a phase reference signal and an output phase signal of the inverter circuit, and the first driving signal is configured to control the inverter circuit.

### CROSS REFERENCE

The present application is based on and claims priority to Chinese Patent Application No. 2023114527298, filed on Nov. 2, 2023, the entire contents of which are incorporated herein by reference.

### TECHNICAL FIELD

The present disclosure relates to the field of wireless power transfer technologies, and in particular, to a power conversion device and a method for controlling the same.

### BACKGROUND

In wireless power transfer systems, under conditions of a specific input voltage, a specific output load, etc., converters usually operate at specific switching frequencies, and Electromagnetic Interference (EMI) generated by the converters are generally concentrated at integer multiples of the switching frequencies.

It should be noted that the information disclosed in the Background section above is only for enhancing the understanding of the background of the present disclosure, and thus may include information that does not constitute prior art known to those of ordinary skill in the art.

### SUMMARY

According to a first aspect of the present disclosure, there is provided a power conversion device, including:
a first Direct Current (DC)-to-DC converter and a control unit;
the control unit includes a phase-locked loop controller;
the first DC-to-DC converter includes a primary side circuit, a secondary side circuit and a transformer, and the transformer is configured to transfer energy between the primary side circuit and the secondary side circuit; the primary side circuit includes an inverter circuit; and
the phase-locked loop controller is configured to output a first driving signal, the first driving signal is generated according to a phase jitter signal, a phase reference signal and an output phase signal of the inverter circuit, and is configured to control the inverter circuit.

According to a second aspect of the present disclosure, there is provided a method for controlling a power conversion device, which is applied to the power conversion device involved in the first aspect and embodiments thereof; the method includes:
generating a first driving signal according to a phase jitter signal, a phase reference signal and an output phase signal of the inverter circuit; and
controlling the inverter circuit by the first driving signal.

It should be noted that the above general description and the following detailed description are merely exemplary and explanatory and should not be construed as limiting of the disclosure.

### BRIEF DESCRIPTION OF THE DRAWINGS

The drawings herein are incorporated in and constitute a part of the specification, illustrate embodiments consistent with the present disclosure, and together with the description serve to explain principles of the present disclosure.

Apparently, the drawings in the following description are only some embodiments of the present disclosure. For those of ordinary skill in the art, other drawings may be obtained based on these drawings without paying any creative effort.

FIG. 1 shows a schematic diagram of a power conversion device according to an embodiment of the present disclosure;

FIG. 2 shows a schematic circuit diagram of a power conversion device according to an embodiment of the present disclosure;

FIG. 3 shows a schematic diagram of a power conversion device including a second DC-to-DC converter according to an embodiment of the present disclosure;

FIG. 4 shows a schematic diagram of a power conversion device including a pre-regulator according to an embodiment of the present disclosure;

FIG. 5 shows a schematic diagram of a power conversion device including an output sampling unit and a pre-regulator controller according to an embodiment of the present disclosure;

FIG. 6 shows a schematic diagram of a power conversion device including a duty cycle jitter unit according to an embodiment of the present disclosure;

FIG. 7 shows a comparison chart of changes in duty cycle jitter, WPT gain change, frequency jitter and phase jitter according to an embodiment of the present disclosure;

FIG. 8 shows a flowchart of a method for determining an amplitude of duty cycle jitter according to an embodiment of the present disclosure;

FIG. 9 shows a schematic diagram of a duty cycle jitter curve and an output ripple curve according to an embodiment of the present disclosure;

FIG. 10 shows a schematic circuit diagram of another power conversion device according to an embodiment of the present disclosure;

FIG. 11 shows a schematic diagram of a power conversion device including a first power command jitter unit according to an embodiment of the present disclosure;

FIG. 12 shows a schematic circuit diagram of yet another power conversion device according to an embodiment of the present disclosure;

FIG. 13 shows a schematic diagram of a power conversion device including an input sampling unit and a power control unit according to an embodiment of the present disclosure;

FIG. 14 shows a schematic diagram of a power conversion device including an output sampling unit and a second power command jitter unit according to an embodiment of the present disclosure;

FIG. 15 shows a schematic circuit diagram of still another power conversion device according to an embodiment of the present disclosure;

FIG. 16 shows a graph of change trends of amplitude (maximum value) and average value of EMI noise when there is no phase jitter according to an embodiment of the present disclosure;

FIG. 17 shows a graph of change trends of amplitude (maximum value) and average value of EMI noise when there is phase jitter according to an embodiment of the present disclosure; and

FIG. 18 shows a flowchart of a method for controlling a power conversion device according to an embodiment of the present disclosure.

### DETAILED DESCRIPTION

In order to make objectives, technical solutions and advantages of the present disclosure more clear, the technical solutions in the present disclosure will be clearly and completely described below in conjunction with the drawings in the present disclosure.

It should be noted that example implementations are part of embodiments of the present disclosure, rather than all the embodiments. The example implementations can be carried out in a variety of forms and should not be construed as being limited to examples set forth herein. All other embodiments obtained by those ordinary skilled in the art without paying any creative effort are within the protection scope of the present disclosure.

Based on the Background section, in wireless power transfer systems, it is difficult for EMI characteristics of the systems to meet descried requirements, resulting in the need for a larger EMI filter and increased costs.

The inventors have found that by adding frequency jitter to make an operating frequency of a converter vary within a certain range, EMI noise can be reduced to a certain extent. In the related arts, in order to adapt to different misalignments and air gap conditions, a variable frequency converter is usually used. For the variable frequency converter, the operating frequency of the converter may vary within a certain range by superimposing voltage pulsation on an output bus of a front-end converter. This solution requires the converter to have a relatively fast dynamic response to follow a change in an input bus to achieve the frequency jitter. However, in the wireless power transfer systems, primary side information and secondary side information need to be transmitted through wireless communication. Limited by wireless communication bandwidths, wireless converters cannot achieve the relatively fast response. Therefore, the above-mentioned frequency jitter scheme of the variable frequency converter cannot be applied to the wireless power transfer systems.

To solve the above problems, embodiments of the present disclosure provide a power conversion device and a method for controlling the power conversion device, which can be applied to a wireless power transfer system and can effectively reduce EMI noise.

In the power conversion device and the method for controlling the same provided in embodiments of the present disclosure, the first driving signal is generated according to the phase jitter signal, the phase reference signal and the output phase signal of the inverter circuit, thereby generating the frequency jitter applied to the inverter circuit, and the frequency jitter participates in the loop control of the phase-locked loop and the inverter circuit. This solution can widen the spectrum to reduce EMI noise.

Example implementations are described in detail below with reference to the accompanying drawings and embodiments.

FIG. 1 shows a power conversion device according to an embodiment of the present disclosure, and the power conversion device operates in a phase-locked loop mode. Under conditions of a specific input voltage, a specific output load, etc., an operating frequency of the power conversion device is often fixed and its gain is also fixed.

As shown in FIG. 1, the power conversion device provided in embodiments of the present disclosure includes a first DC-to-DC converter 1 and a control unit 2.

The first DC-to-DC converter 1 includes a primary side circuit 11, a secondary side circuit 12 and a transformer 13. The transformer 13 transfers energy between the primary side circuit 11 and the secondary side circuit 12. In some embodiments, the transformer 13 may be non-isolated. Two ends of the first DC-to-DC converter 1 are connected to a power supply and a load, respectively.

The primary side circuit 11 includes an inverter circuit 111. The control unit 2 includes a phase-locked loop controller 21, and the phase-locked loop controller 21 is connected to the inverter circuit 111.

The phase-locked loop controller 21 outputs a first driving signal, which is generated according to a phase jitter signal, a phase reference signal and an output phase signal of the inverter circuit, and is configured to control the inverter circuit 111. The phase-locked loop controller 21 performs closed-loop control of the inverter circuit 111 through the first driving signal.

In some embodiments, the generation of the first driving signal according to the phase jitter signal, the phase reference signal, and the output phase signal of the inverter circuit may be generating a new phase reference signal according to the output phase signal of the inverter circuit and an original phase reference signal, and then superimposing the phase jitter signal on the new phase reference signal to generate the first driving signal.

In some embodiments, the phase-locked loop controller 21 acquires a voltage-current phase difference of the primary side circuit, controls an operating frequency of the inverter circuit 111 according to the voltage-current phase difference and a preset phase difference to make the voltage-current phase difference equal to the preset phase difference, realizing the closed-loop control of the inverter circuit 111.

In some embodiments, the inverter circuit 111 may be a half-bridge inverter circuit or a full-bridge inverter circuit.

The inverter circuit receives DC power from the power supply and converts the DC power into Alternating Current (AC) power. The transformer receives the AC power output by the inverter circuit and transfers it to the secondary side circuit, which receives the AC power and converts it into the DC power.

In some embodiments, the primary side circuit may further include a primary side compensation circuit coupled between the inverter circuit and the transformer, and the inverter circuit is connected to the power supply. The secondary side circuit includes a secondary side compensation circuit and a rectifier circuit, the secondary side compensation circuit is coupled between the transformer and the rectifier circuit, and the rectifier circuit is connected to the load.

The transformer may include a transmitting coil and a receiving coil. The primary side compensation circuit is configured to compensate for part of reactive power of the transmitting coil of the transformer, and the secondary side compensation circuit is configured to compensate for reactive power of the receiving coil of the transformer.

The rectifier circuit receives the AC power and converts it into the DC power.

In some embodiments, the rectifier circuit may be a full-wave rectifier circuit or a full-bridge rectifier circuit.

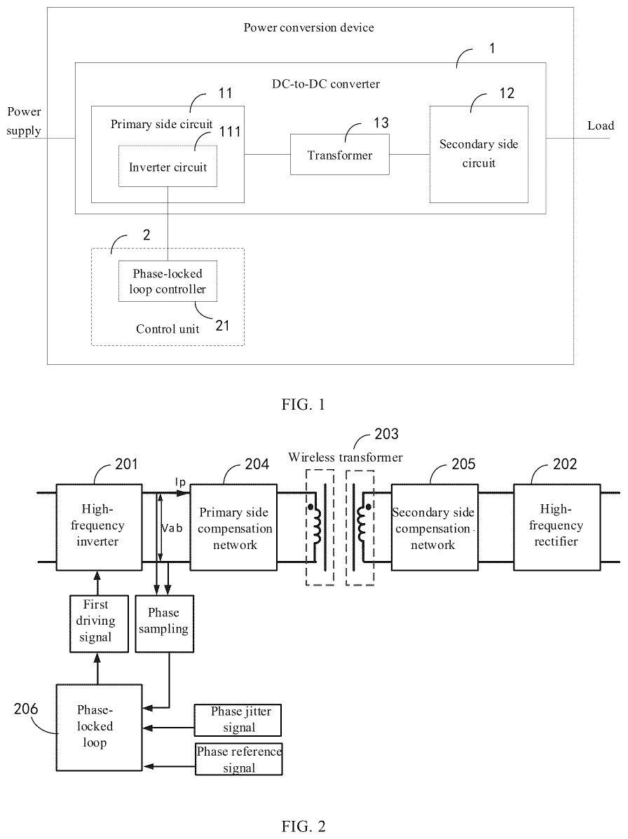

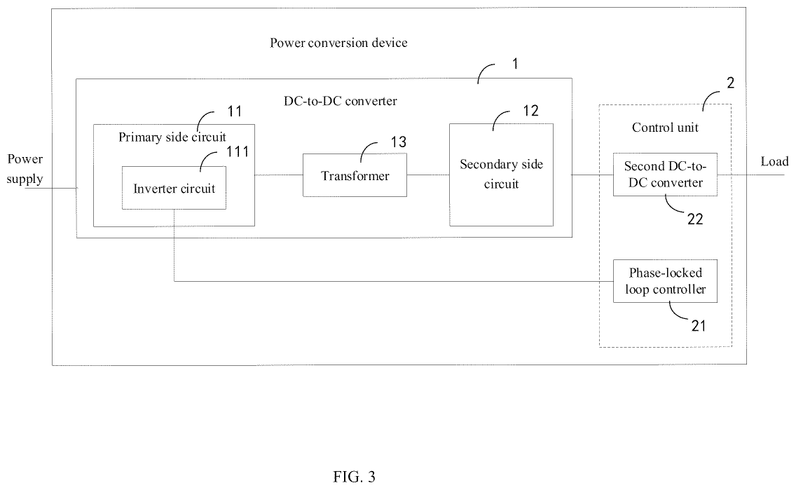

FIG. 2 shows a schematic circuit diagram of a power conversion device according to an embodiment of the present disclosure. As shown in FIG. 2, the power conversion device includes a high-frequency inverter 201, a high-frequency rectifier 202, a wireless transformer 203, a primary side compensation network 204, a secondary side compensation network 205 and a phase-locked loop 206.

The inverter circuit in the above embodiments is the high-frequency inverter 201 in FIG. 2, the rectifier circuit in the above embodiments is the high-frequency rectifier 202 in FIG. 2, and the transformer in the above embodiments is the wireless transformer 203 in FIG. 2.

In embodiments of the present disclosure, phase jitter is added to the phase-locked loop, thereby generating the frequency jitter applied to the driving signal of the inverter circuit, so that the driving signal has the jitter within a frequency range, rather than having the jitter at a specific operating frequency, which can effectively reduce the EMI noise. Furthermore, in the embodiments of the present disclosure, the phase jitter signal is used as a part of the reference signal, and the reference signal with the phase jitter signal added is used to drive the phase-locked loop controller, which can widen the frequency spectrum.

In some embodiments, the power conversion device may further include a second DC-to-DC converter provided between the first DC-to-DC converter and the load in the above embodiments. By adopting this solution, an output ripple caused by a gain change of the first DC-to-DC converter in the above embodiments can be suppressed by increasing a control loop bandwidth. A structure of the power conversion device in this embodiment is shown in FIG. 3.

The power conversion device shown in FIG. 3 includes the first DC-to-DC converter 1 and the control unit 2. The first DC-to-DC converter 1 includes the primary side circuit 11, the secondary side circuit 12 and the transformer 13, and the primary side circuit 11 includes the inverter circuit 111. The control unit 2 includes the phase-locked loop controller 21 and a second DC-to-DC converter 22.

The structure and function of the first DC-to-DC converter 1 in the embodiment of FIG. 3 are the same as those in the embodiment of FIG. 1, and will not be described in detail herein.

Compared with the embodiment of FIG. 1, the control unit 2 in the embodiment of FIG. 3 is further provided with the second DC-to-DC converter 22. The second DC-to-DC converter 22 is coupled between the first DC-to-DC converter 1 and an output end of the power conversion device, that is, coupled between the first DC-to-DC converter 1 and the load.

In some embodiments, the second DC-to-DC converter 22 is configured to adjust an output signal of the first DC-to-DC converter 1, and the second DC-to-DC converter 22 may be any one of a buck circuit, a boost circuit, or a buck-boost circuit.

In the above embodiments, by increasing the control loop bandwidth, the second DC-to-DC converter 22 can improve the output ripple caused by the gain change of the first DC-to-DC converter 1.

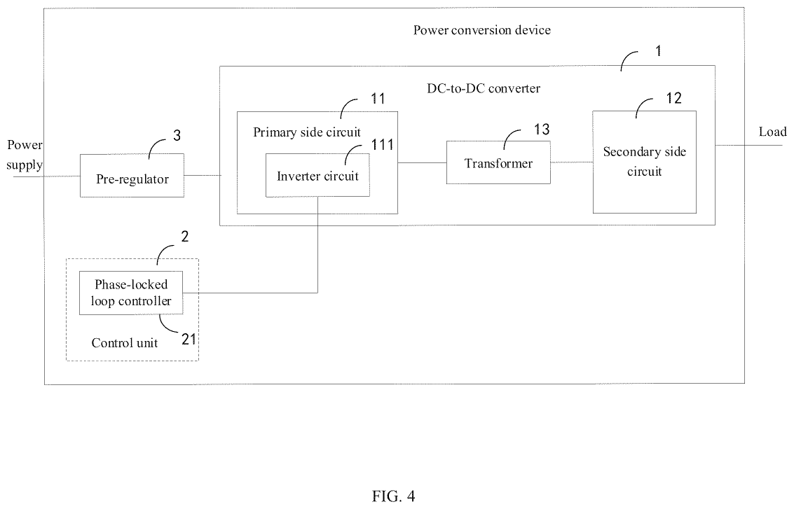

In some embodiments, the power conversion device may further include a pre-regulator, which is coupled between the first DC-to-DC converter and the power supply. The structure of the power conversion device in this embodiment is shown in FIG. 4.

In some embodiments, the pre-regulator is configured to regulate an input signal of the first DC-to-DC converter 1, and the pre-regulator may be any one of the buck circuit, the boost circuit, or the buck-boost circuit.

The power conversion device shown in FIG. 4 includes the first DC-to-DC converter 1, the control unit 2 and a pre-regulator 3. The first DC-to-DC converter 1 includes the primary side circuit 11, the secondary side circuit 12 and the transformer 13, and the primary side circuit 11 includes the inverter circuit 111. The control unit 2 includes the phase-locked loop controller 21.

In the above embodiment, the pre-regulator 3 has a first voltage gain, and the first DC-to-DC converter 1 has a second voltage gain. When the second voltage gain changes, the pre-regulator 3 makes the first voltage gain change inversely, so that a total gain of the system remains basically unchanged, thereby improving the output ripple.

In the above embodiments, the second voltage gain is a gain change of the first DC-to-DC converter caused by the frequency jitter.

In some embodiments, a relationship between the first voltage gain, the second voltage gain and the total gain is as shown in the following formula:

$${Gain}_{total} = {Gain}_{pre - regulator} * {Gain}_{WPT} \qquad ( 1 )$$

where, Gainₜₒₜₐₗ represents the total gain, Gain_{pre-regulator} represents the first voltage gain, and Gain_{WPT} represents the second voltage gain.

In some embodiments, when the primary side and the secondary side are of the structure shown in FIG. 4, that is, a primary-side series compensation and a secondary-side series compensation, change trends of the first voltage gain, the second voltage gain and the total gain are as follows:

$$\begin{matrix}Phase ↑ -> fs ↑ -> {Gain}_{WPT} ↓ \\ {Gain}_{pre - regulator} ↑\end{matrix} \} {Gain}_{total} \qquad ( 2 )$$

It should be noted that the above formula is only an example of a changing relationship between phase, frequency and gain. The changing relationship between phase, frequency and gain can also be in other forms, and specific changes may be related to the primary side compensation and the secondary side compensation or connection relationships of the primary side and the secondary side.

In embodiments of the present disclosure, a gain of the pre-regulator is made to present a trend opposite to the gain change of the first DC-to-DC converter, so that the total gain of the system remains basically unchanged, and the output ripple can be improved.

In addition, compared with the embodiment of FIG. 3, the receiver of the embodiment of FIG. 4 is smaller in size, lighter in weight, and more practical.

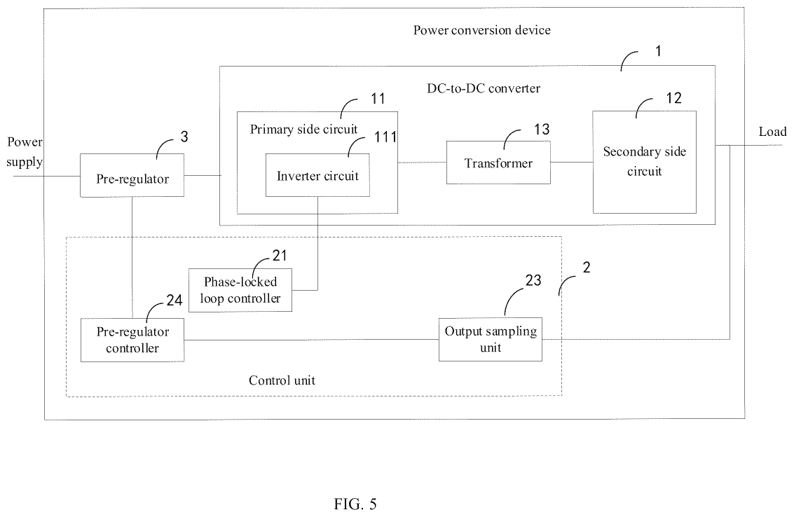

In some embodiments, the control unit may further include an output sampling unit and a pre-regulator controller. The structure of the power conversion device in this embodiment is shown in FIG. 5.

The power conversion device shown in FIG. 5 includes the first DC-to-DC converter 1, the control unit 2 and the pre-regulator 3. The first DC-to-DC converter 1 includes the primary side circuit 11, the secondary side circuit 12 and the transformer 13, and the primary side circuit 11 includes the inverter circuit 111. The control unit 2 includes the phase-locked loop controller 21, an output sampling unit 23 and a pre-regulator controller 24.

In some embodiments, the output sampling unit 23 is configured to detect an output power of the power conversion device and provide a power detection value, that is, to acquire an output power feedback value of the first DC-to-DC converter 1. In addition, the output sampling unit 23 is further configured to acquire output ripple information of the first DC-to-DC converter 1.

In some embodiments, the output sampling unit 23 may include an output current detection module, an output voltage detection module and an output ripple detection module. The output current detection module is configured to detect an output current and provide a current detection value. The output voltage detection module is configured to detect an output voltage and provide a voltage detection value. The output power feedback value may be determined based on the current detection value and/or the voltage detection value. The output ripple detection module is configured to detect the output ripple and provide the output ripple information.

In some embodiments, the output sampling unit 23 is configured to acquire the output ripple information and the output power feedback value of the first DC-to-DC converter 1. The pre-regulator controller 24 provides a second driving signal to the pre-regulator converter 3 according to the output ripple information and the output power feedback value of the first DC-to-DC converter 1. The second driving signal is configured to make the gain of the pre-regulator 3 present a trend opposite to the gain change of the first DC-to-DC converter 1, so that the total gain of the system remains basically unchanged, thereby improving the output ripple.

It should be noted that the second driving signal is generated based on the above-mentioned output ripple information and output power feedback value. The output power feedback value is mainly configured to generate a basic driving duty cycle, and the output ripple information is configured to adjust an amplitude of the duty cycle jitter.

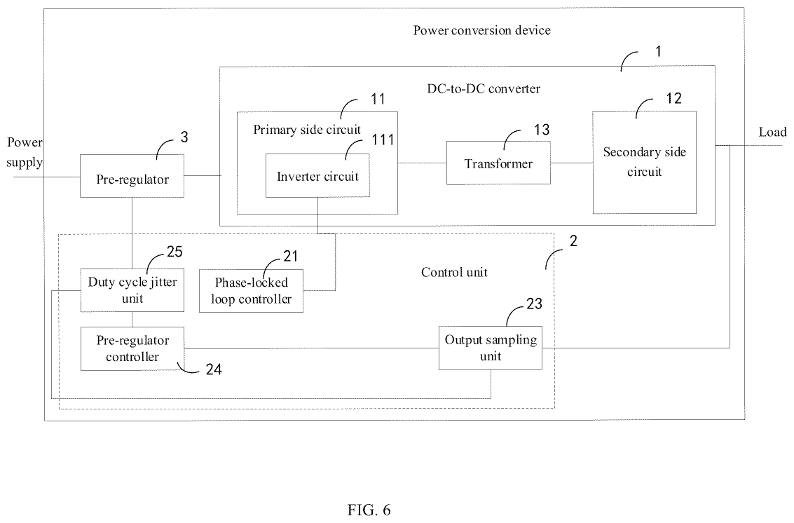

In some embodiments, the control unit may further include a duty cycle jitter unit. The structure of the power conversion device in this embodiment is shown in FIG. 6.

The power conversion device shown in FIG. 6 includes the first DC-to-DC converter 1, the control unit 2 and the pre-regulator 3. The first DC-to-DC converter 1 includes the primary side circuit 11, the secondary side circuit 12 and the transformer 13, and the primary side circuit 11 includes the inverter circuit 111. The control unit 2 includes the phase-locked loop controller 21, the output sampling unit 23, the pre-regulator controller 24 and a duty cycle jitter unit 25.

The duty cycle jitter unit 25 is coupled to the pre-regulator 3 and the pre-regulator controller 24. The duty cycle jitter unit 25 is also connected to the output sampling unit 23.

The duty cycle jitter unit 25 generates a duty cycle jitter signal based on the output ripple information of the first DC-to-DC converter, and superimposes the duty cycle jitter signal on a control signal of the pre-regulator controller to generate the second driving signal. The duty cycle jitter signal and the phase jitter signal have the same frequency, and the same or opposite phases, and an amplitude of the duty cycle jitter signal is determined according to the output ripple information of the first DC-to-DC converter.

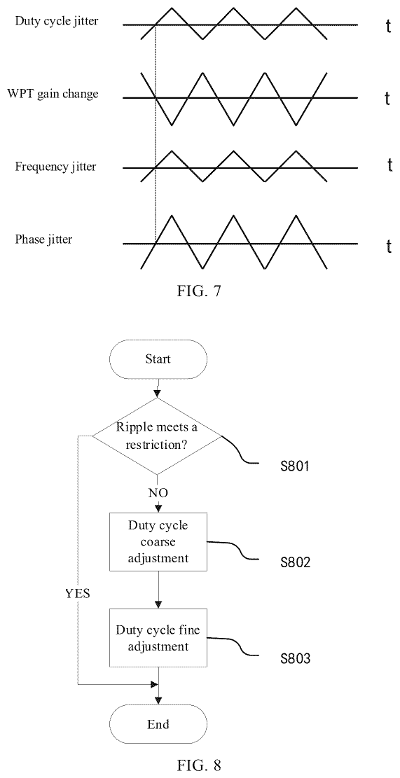

Taking the duty cycle jitter of the series-to-series compensation and a buck-boost converter as an example, changes in the duty cycle jitter, the WPT gain change (the second gain mentioned above), the frequency jitter and the phase jitter are shown in FIG. 7.

The frequency and amplitude of the phase jitter are preset values. The duty cycle jitter and the phase jitter have the same frequency and the same or opposite phases, and the amplitude is obtained by an optimization algorithm. The duty cycle jitter and the phase jitter have the same or opposite phases, which is determined by the effect of the frequency change on a gain of the wireless converter.

For the wireless converter using the series-to-series compensation, the gain decreases and the phase increases when the frequency increases, so the duty cycle jitter and the phase jitter should be in phase.

FIG. 8 shows a method for determining an amplitude of duty cycle jitter. As shown in FIG. 8, in S801, it is first determined whether a ripple meets a restriction condition. When the restriction condition is not met, S802 and S803 are executed to perform duty cycle coarse adjustment and duty cycle fine adjustment.

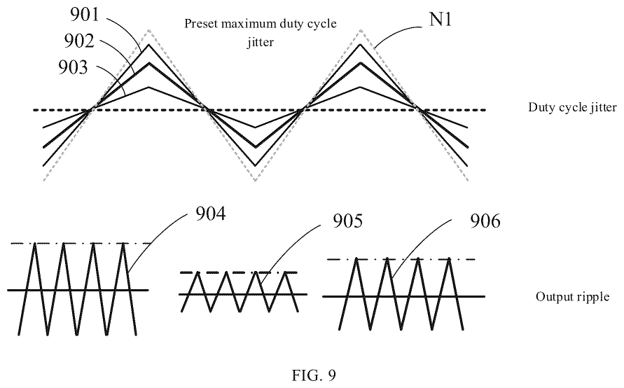

The following describes the process of the duty cycle coarse adjustment and the duty cycle fine adjustment in conjunction with FIG. 9. As shown in FIG. 9, according to a preset maximum duty cycle jitter value and a preset adjustment number N1, N1 different duty cycle jitter values are applied, respectively, including a duty cycle jitter curve 901, a duty cycle jitter curve 902 and a duty cycle jitter curve 903. Each jitter value is maintained for a time T1, and an output ripple amplitude is acquired. The output ripple curve 904 corresponds to the duty cycle jitter curve 901, the output ripple curve 905 corresponds to the duty cycle jitter curve 902, and the output ripple curve 906 corresponds to the duty cycle jitter curve 903. The duty cycle jitter corresponding to the minimum output ripple is taken as an optimal duty cycle jitter value.

In embodiments of the present disclosure, a suitable amplitude of the duty cycle jitter can be determined to alleviate under-compensation or over-compensation for the gain of the wireless converter caused by the excessively large or small amplitude of the duty cycle jitter, thereby improving the output ripple.

In embodiments of the present disclosure, the duty cycle jitter unit obtains the output ripple information from the secondary side. When the power conversion device is used for the charge of an energy storage device such as a battery, the ripple tends to be stable and the fast response is not required, thereby being not affected by a wireless communication delay.

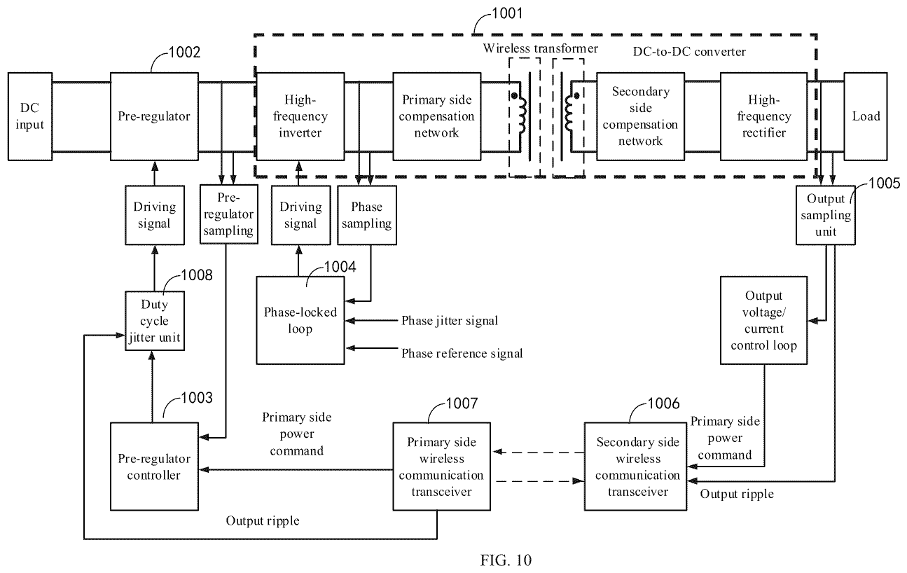

FIG. 10 shows a schematic circuit diagram of a power conversion device according to an embodiment of the present disclosure. As shown in FIG. 10, the power conversion device includes a first DC-to-DC converter 1001, a pre-regulator 1002, a pre-regulator controller 1003, a phase-locked loop 1004, an output sampling unit 1005, a secondary side wireless communication transceiver 1006, a primary side wireless communication transceiver 1007 and a duty cycle jitter unit 1008.

In this embodiment, the output sampling unit 1005 and the pre-regulator controller 1003 communicate via a wireless communication device (the secondary side wireless communication transceiver 1006 and the primary side wireless communication transceiver 1007). There is a delay between the output sampling unit 1005 and the pre-regulator controller 1003, and thus the fast response is impossible. In the absence of the duty cycle jitter unit 1008, the effect of improving the output ripple caused by the gain change of the first DC-to-DC converter will be deteriorated.

In the above embodiments, the duty cycle jitter unit obtains the output ripple information from the secondary side. When the power conversion device is used for the charge of an energy storage device such as a battery, the ripple tends to be stable and the fast response is not required, thereby being not affected by a wireless communication delay.

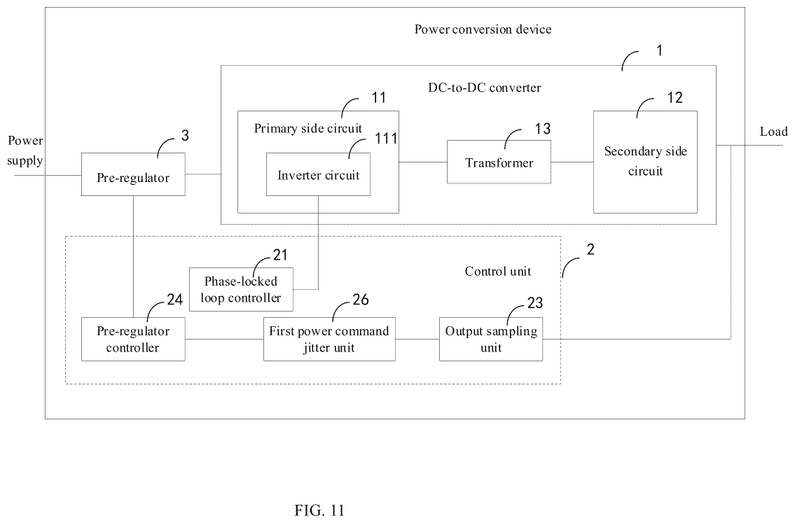

In some embodiments, the control unit may further include a first power command jitter unit. The structure of the power conversion device in this embodiment is shown in FIG. 11.

The power conversion device shown in FIG. 11 includes the first DC-to-DC converter 1, the control unit 2 and the pre-regulator 3. The first DC-to-DC converter 1 includes the primary side circuit 11, the secondary side circuit 12 and the transformer 13, and the primary side circuit 11 includes the inverter circuit 111. The control unit 2 includes the phase-locked loop controller 21, the output sampling unit 23, the pre-regulator controller 24 and a first power command jitter unit 26.

The first power command jitter unit 26 generates a power command jitter signal based on the output ripple information of the first DC-to-DC converter 1, and the pre-regulator controller 24 generates the second driving signal according to the power command jitter signal. The power command jitter signal and the phase jitter signal have the same frequency, and the same or opposite phases, and an amplitude of the power command jitter signal is determined based on the output ripple information of the first DC-to-DC converter.

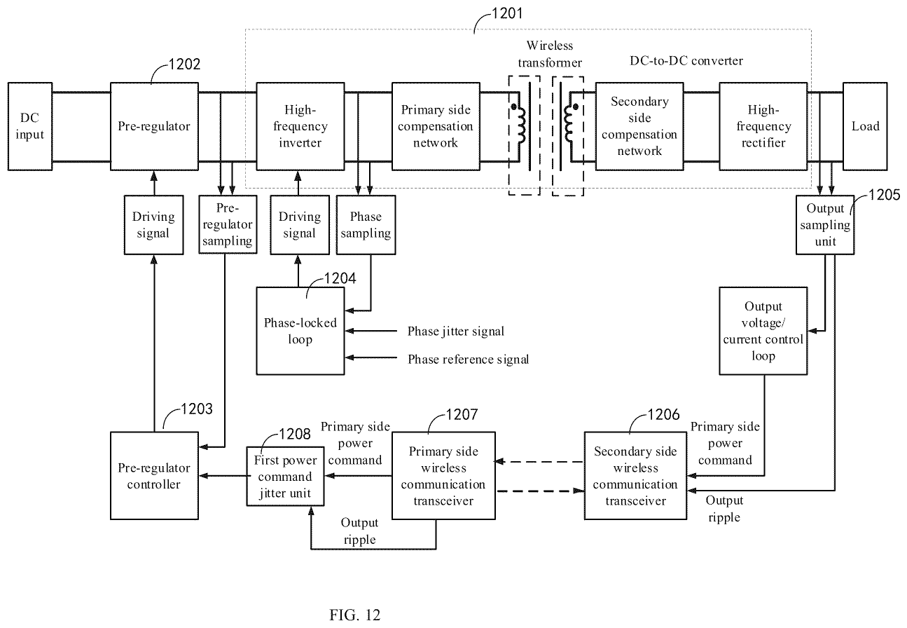

FIG. 12 shows a schematic circuit diagram of a power conversion device according to an embodiment of the present disclosure. As shown in FIG. 12, the power conversion device includes a first DC-to-DC converter 1201, a pre-regulator 1202, a pre-regulator controller 1203, a phase-locked loop 1204, an output sampling unit 1205, a secondary side wireless communication transceiver 1206, a primary side wireless communication transceiver 1207 and a first power command jitter unit 1208.

The first power command jitter unit obtains the output ripple information from the secondary side. When the power conversion device is used for the charge of an energy storage device such as a battery, the ripple tends to be stable and the fast response is not required, so the wireless communication delay will not affect the effect of this solution.

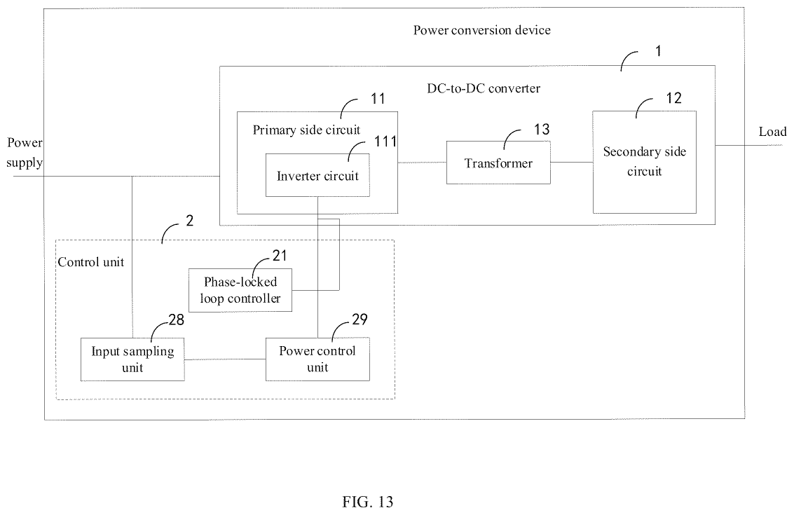

In some embodiments, the control unit may further include an input sampling unit and a power control unit. The structure of the power conversion device in this embodiment is shown in FIG. 13.

The power conversion device shown in FIG. 13 includes the first DC-to-DC converter 1 and the control unit 2. The first DC-to-DC converter 1 includes the primary side circuit 11, the secondary side circuit 12 and the transformer 13, and the primary side circuit 11 includes the inverter circuit 111. The control unit 2 includes the phase-locked loop controller 21, an input sampling unit 28 and a power control unit 29.

The input sampling unit 28 is configured to acquire an input power feedback value of the first DC-to-DC converter 1. The power control unit 29 is configured to generate a first duty cycle or a first phase shift angle according to a primary side power command and the input power feedback value of the first DC-to-DC converter 1, and generate a third driving signal based on the first duty cycle or the first phase shift angle in combination with the first driving signal.

In the above embodiments, based on a single-stage DC-to-DC converter, the phase-locked loop is used to control the operating frequency of the first DC-to-DC converter. The power control unit generates the first duty cycle or the first phase shift angle according to the primary side power command and the input power feedback value of the first DC-to-DC converter, and generates the third driving signal based on the first duty cycle or the first phase shift angle in combination with the first driving signal. The output power is controlled by the third driving signal, which can improve the output ripple caused by the gain change of the first DC-to-DC converter 1. The output ripple is mainly improved based on a primary side parameter, thereby being less affected by the wireless communication delay.

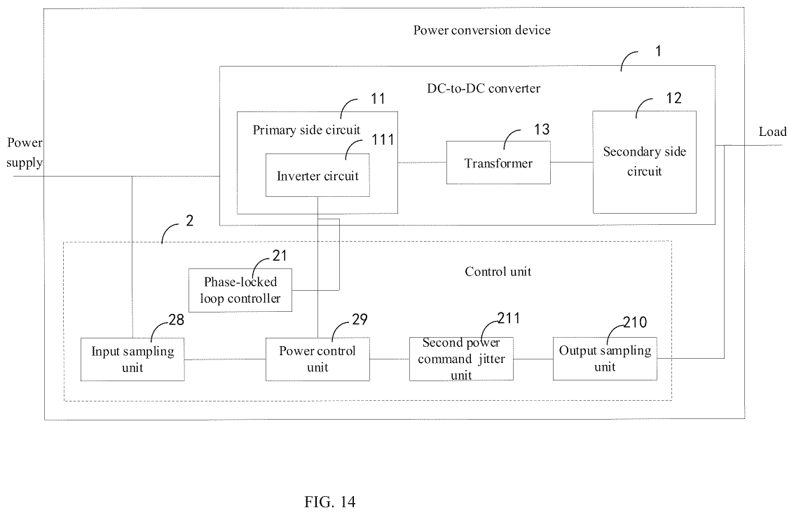

In some embodiments, the control unit may further include an output sampling unit and a second power command jitter unit. The structure of the power conversion device in this embodiment is shown in FIG. 14.

The power conversion device shown in FIG. 14 includes the first DC-to-DC converter 1 and the control unit 2. The first DC-to-DC converter 1 includes the primary side circuit 11, the secondary side circuit 12 and the transformer 13, and the primary side circuit 11 includes the inverter circuit 111. The control unit 2 includes the phase-locked loop controller 21, the input sampling unit 28, the power control unit 29, an output sampling unit 210 and a second power command jitter unit 211.

The output sampling unit 210 is configured to acquire the output ripple information of the first DC-to-DC converter 1. The second power command jitter unit 211 generates a power command jitter signal based on the output ripple information of the first DC-to-DC converter 1, and sends the power command jitter signal to the power control unit 29, so that the power control unit 29 superimposes a duty cycle or a phase shift angle of the power command jitter signal on the first duty cycle or the first phase shift angle of the power control signal to generate a fourth driving signal.

The power command jitter signal and the phase jitter signal have the same frequency and the same or opposite phases, and an amplitude of the power command jitter signal is determined based on the output ripple information of the first DC-to-DC converter.

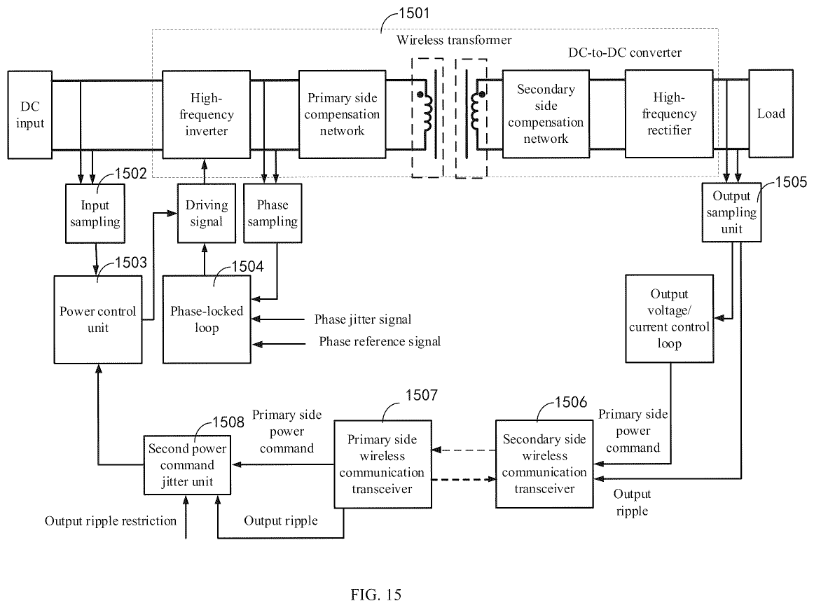

FIG. 15 shows a schematic circuit diagram of a power conversion device according to an embodiment of the present disclosure. As shown in FIG. 15, the power conversion device includes a first DC-to-DC converter 1501, an input sampling unit 1502, a power control unit 1503, a phase-locked loop 1504, an output sampling unit 1505, a secondary side wireless communication transceiver 1506, a primary side wireless communication transceiver 1507 and a second power command jitter unit 1508.

In the above embodiments, the second power command jitter unit obtains the output ripple information from the secondary side. When the power conversion device is used for the charge of an energy storage device such as a battery, the ripple tends to be stable and the fast response is not required, so the wireless communication delay will not affect the effect of this solution.

In the above various embodiments of the power conversion device, the EMI noise can be effectively reduced by means of the phase jitter. By providing the second DC-to-DC converter, the pre-regulator or the power control unit, a good output ripple can be ensured while effectively reducing the EMI noise.

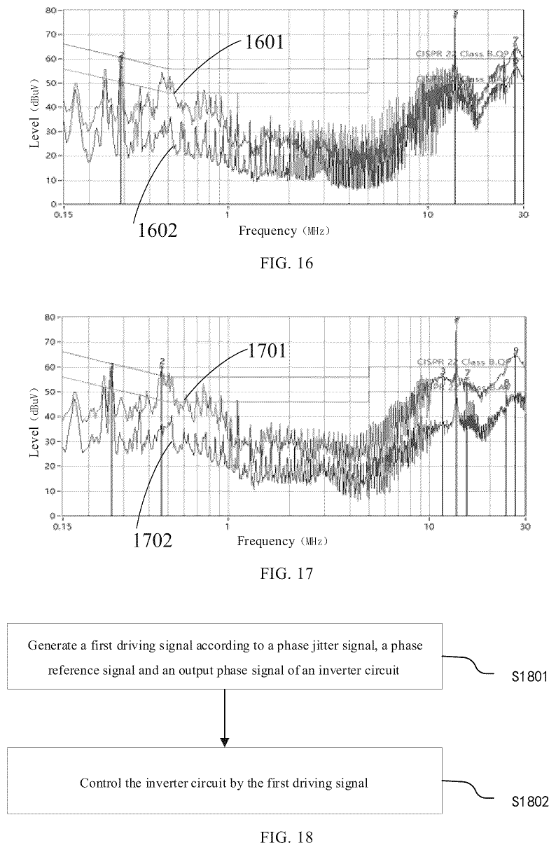

FIG. 16 shows a graph of change trends of amplitude (maximum value) and average value of EMI noise when there is no phase jitter. The curve 1601 represents a change trend of the amplitude (maximum value) of the noise, and the curve 1602 represents a change trend of the average value of the noise. FIG. 17 shows a graph of change trends of amplitude (maximum value) and average value of EMI noise when there is phase jitter. The curve 1701 represents a change trend of the amplitude (maximum value) of the noise, and the curve 1702 represents a change trend of the average value of the noise. With reference to FIG. 16 and FIG. 17, it can be seen that the phase jitter adopted in the present disclosure can effectively reduce the EMI noise.

In addition, the applicant has summarized output current ripple cases, as shown in the following table:

TABLE 1

| | Solution without | Solution with | Improved |
|---|---|---|---|
| | phase jitter | phase jitter | solution |
| Output | 6.3 Apk-pk | 10.2 Apk-pk | 6.3 Apk-pk |
| current | | | |
| ripple/Apk-pk | | | |

The improved solution in Table 1 is a solution of providing the second DC-to-DC converter, the pre-regulator or the power control unit in the above embodiments. It can be seen from Table 1 that the improved solution proposed in embodiments of the present disclosure can effectively reduce the EMI noise while ensuring the good output ripple.

In embodiments of the present disclosure, the terms “first”, “second” and “third” are used for descriptive purposes only and should not be understood as indicating or implying relative importance. The concepts of “first”, “second” and the like mentioned in the present disclosure are only used to distinguish different devices, modules or units, and are not used to limit the order or interdependence of functions performed by these devices, modules or units.

It should be noted that although several modules or units of devices for executing actions are mentioned in the above detailed description, such division of modules or units is not mandatory.

In practice, features and functions of two or more modules or units described above may be embodied in one module or unit in accordance with the embodiments of the present disclosure. Alternatively, the features and functions of one module or unit described above may be further divided into multiple modules or units.

Some of the block diagrams shown in the figures are functional entities and do not necessarily correspond to physically or logically separate entities. These functional entities may be implemented in software, or implemented in one or more hardware modules or integrated circuits, or implemented in different networks and/or processor devices and/or microcontroller devices.

Embodiments of the present disclosure further provide a method for controlling a power conversion device, which is configured to control the power conversion device provided by any of the above embodiments. As shown in FIG. 18, the method for controlling the power conversion device includes steps S1801 to S1802.

In the S1801, a phase-locked loop controller generates a first driving signal according to a phase jitter signal, a phase reference signal, and an output phase signal of an inverter circuit.

In the S1802, the phase-locked loop controller controls the inverter circuit by the first driving signal. The phase-locked loop controller acquires a voltage-current phase difference of a primary side circuit, and controls an operating frequency of the inverter circuit according to the voltage-current phase difference and a preset phase difference to make the voltage-current phase difference equal to the preset phase difference, realizing the closed-loop control of the inverter circuit.

In embodiments of the present disclosure, phase jitter is added to the phase-locked loop, thereby generating the frequency jitter applied to the driving signal of the inverter circuit, so that the driving signal has the jitter within a frequency range, rather than having the jitter at a specific operating frequency, which can effectively reduce the EMI noise. Furthermore, in the embodiments of the present disclosure, the phase jitter signal is used as a part of the reference signal, and the reference signal with the phase jitter signal added is used to drive the phase-locked loop controller, which can widen the frequency spectrum.

In some embodiments, the control unit may further include a second DC-to-DC converter provided between the first DC-to-DC converter and the load in the above embodiments. When this solution is adopted, the method for controlling the power conversion device further includes increasing a control loop bandwidth, that is, improving the loop response, thereby achieving an effect of optimizing the output ripple.

In some embodiments, the power conversion device may further include a pre-regulator coupled between the first DC-to-DC converter and the power supply, and in these embodiments, the pre-regulator has a first voltage gain, and the first DC-to-DC converter has a second voltage gain. The method for controlling the power conversion device further includes: when the second voltage gain changes, the pre-regulator makes the first voltage gain change inversely, so that the total gain of the system remains substantially unchanged, and the output ripple can be improved.

In some embodiments, the control unit may further include a duty cycle jitter unit coupled to the pre-regulator and the pre-regulator controller, and the duty cycle jitter unit is also connected to the output sampling unit. The method for controlling the power conversion device further includes: the duty cycle jitter unit generates a duty cycle jitter signal based on the output ripple information of the first DC-to-DC converter, and superimposes the duty cycle jitter signal on the control signal of the pre-regulator controller to generate a second driving signal. The duty cycle jitter signal and the phase jitter signal have the same frequency, and the same or opposite phases, and an amplitude of the duty cycle jitter signal is determined according to the output ripple information of the first DC-to-DC converter.

In embodiments of the present disclosure, the duty cycle jitter unit obtains the output ripple information from the secondary side. When the power conversion device is used for the charge of an energy storage device such as a battery, the ripple tends to be stable and the fast response is not required, thereby being not affected by a wireless communication delay.

In some embodiments, the control unit may further include a first power command jitter unit, and the method for controlling the power conversion device further includes: the first power command jitter unit generates a power command jitter signal based on the output ripple information of the first DC-to-DC converter, and the pre-regulator controller generates the second driving signal according to the power command jitter signal. The power command jitter signal and the phase jitter signal have the same frequency, and the same or opposite phases, and an amplitude of the power command jitter signal is determined based on the output ripple information of the first DC-to-DC converter.

The first power command jitter unit obtains the output ripple information from the secondary side. When the power conversion device is used for the charge of an energy storage device such as a battery, the ripple tends to be stable and the fast response is not required, thereby being not affected by a wireless communication delay.

In some embodiments, the control unit may further include an input sampling unit and a power control unit. The method for controlling the power conversion device further includes: the input sampling unit acquires an input power feedback value of the first DC-to-DC converter; and the power control unit generates, according to a primary side power command and the input power feedback value of the first DC-to-DC converter, a first duty cycle or a first phase shift angle to act on the first driving signal to generate a third driving signal.

In the above embodiments, based on a single-stage first DC-to-DC converter, the phase-locked loop is used to control the operating frequency of the first DC-to-DC converter. The power control unit generates, according to the primary side power command and the input power feedback value of the first DC-to-DC converter, the first duty cycle or the first phase shift angle to act on the first driving signal to generate the third driving signal. The output power is controlled by the third driving signal, which can improve the output ripple caused by the gain change of the first DC-to-DC converter 1, and there is no need to acquire the secondary side information, thereby being not affected by the wireless communication delay.

In some embodiments, the control unit may further include an output sampling unit and a second power command jitter unit. The method for controlling the power conversion device further includes: the output sampling unit acquires the output ripple information of the first DC-to-DC converter; the second power command jitter unit generates a power command jitter signal based on the output ripple information of the first DC-to-DC converter, and sends the power command jitter signal to the power control unit, so that the power control unit superimposes the duty cycle or the phase shift angle of the power command jitter signal on the first duty cycle or the first phase shift angle of the power control signal to generate a fourth driving signal. The power command jitter signal and the phase jitter signal have the same frequency, and the same or opposite phases, and an amplitude of the power command jitter signal is determined based on the output ripple information of the first DC-to-DC converter.

In the above embodiments, the second power command jitter unit obtains the output ripple information from the secondary side. When the power conversion device is used for the charge of an energy storage device such as a battery, the ripple tends to be stable and the fast response is not required, thereby being not affected by a wireless communication delay.

The above various embodiments are only used to illustrate the technical solutions of the present disclosure, rather than to limit it. The present disclosure is intended to cover any variations, uses, or adaptations of the present disclosure, which are in accordance with the general principles of the present disclosure and include common general knowledge or conventional technical means in the art that are not disclosed in the present disclosure. The specification and embodiments are illustrative, and the real scope and spirit of the present disclosure is defined by the appended claims.

What is claimed is:

1. A power conversion device, comprising:
a first Direct Current (DC)-to-DC converter, comprising a primary side circuit, a secondary side circuit and a transformer, wherein the transformer is configured to transfer energy between the primary side circuit and the secondary side circuit, and the primary side circuit comprises an inverter circuit; and
a control unit, comprising a phase-locked loop controller configured to output a first driving signal, wherein the first driving signal is generated according to a phase jitter signal, a phase reference signal and an output phase signal of the inverter circuit, and is configured to control the inverter circuit.

2. The power conversion device according to claim 1, further comprising:
a pre-regulator, coupled between the first DC-to-DC converter and a power supply, and having a first voltage gain;
the first DC-to-DC converter has a second voltage gain; and
when the second voltage gain changes, the pre-regulator is configured to make the first voltage gain change inversely.

3. The power conversion device according to claim 2, wherein the control unit further comprises an output sampling unit and a pre-regulator controller;
the output sampling unit is configured to acquire output ripple information and an output power feedback value of the first DC-to-DC converter; and
the pre-regulator controller is configured to provide a second driving signal to the pre-regulator according to the output ripple information and the output power feedback value of the first DC-to-DC converter.

4. The power conversion device according to claim 3, wherein the control unit further comprises a duty cycle jitter unit, configured to generate a duty cycle jitter signal based on the output ripple information of the first DC-to-DC converter, and superimpose the duty cycle jitter signal on a control signal of the pre-regulator controller to generate the second driving signal; and
the duty cycle jitter signal and the phase jitter signal have the same frequency and the same or opposite phases, and an amplitude of the duty cycle jitter signal is determined based on the output ripple information of the first DC-to-DC converter.

5. The power conversion device according to claim 3, wherein the control unit further comprises a first power command jitter unit, configured to generate a power command jitter signal based on the output ripple information of the first DC-to-DC converter, and the pre-regulator controller is configured to generate the second driving signal according to the power command jitter signal; and
the power command jitter signal and the phase jitter signal have the same frequency and the same or opposite phases, and an amplitude of the power command jitter signal is determined based on the output ripple information of the first DC-to-DC converter.

6. The power conversion device according to claim 1, wherein the control unit further comprises an input sampling unit and a power control unit;
the input sampling unit is configured to acquire an input power feedback value of the first DC-to-DC converter; and
the power control unit is configured to generate, according to a primary side power command and the input power feedback value of the first DC-to-DC converter, a first duty cycle or a first phase shift angle to act on the first driving signal to generate a third driving signal.

7. The power conversion device according to claim 6, wherein the control unit further comprises an output sampling unit and a second power command jitter unit;
the output sampling unit is configured to acquire output ripple information of the first DC-to-DC converter;
the second power command jitter unit is configured to generate a power command jitter signal based on the output ripple information of the first DC-to-DC converter, and send the power command jitter signal to the power control unit to make the power control unit superimpose a duty cycle or a phase shift angle of the power command jitter signal on a first duty cycle or a first phase shift angle of a power control signal to generate a fourth driving signal; and
the power command jitter signal and the phase jitter signal have the same frequency and the same or opposite phases, and an amplitude of the power command jitter signal is determined based on the output ripple information of the first DC-to-DC converter.

8. The power conversion device according to claim 1, wherein the control unit further comprises:
a second DC-to-DC converter, coupled between the first DC-to-DC converter and a load.

9. A method for controlling a power conversion device, wherein the power conversion device comprises:
a first Direct Current (DC)-to-DC converter, comprising a primary side circuit, a secondary side circuit and a transformer, wherein the transformer is configured to transfer energy between the primary side circuit and the secondary side circuit, and the primary side circuit comprises an inverter circuit; and
a control unit, comprising a phase-locked loop controller,
wherein the method comprises:
generating, by the phase-locked loop controller, a first driving signal according to a phase jitter signal, a phase reference signal and an output phase signal of the inverter circuit; and
controlling the inverter circuit by the first driving signal.

10. The method for controlling the power conversion device according to claim 9,
wherein the power conversion device comprises a pre-regulator coupled between the first DC-to-DC converter and a power supply; the pre-regulator has a first voltage gain, and the first DC-to-DC converter has a second voltage gain;
the method for controlling the power conversion device further comprises:
when the second voltage gain changes, making, by the pre-regulator, the first voltage gain change inversely.

11. The method for controlling the power conversion device according to claim 9, wherein the control unit further comprises a duty cycle jitter unit coupled between a pre-regulator and a pre-regulator controller, and the duty cycle jitter unit is further connected to an output sampling unit;
the method for controlling the power conversion device further comprises:
generating, by the duty cycle jitter unit, a duty cycle jitter signal based on output ripple information of the first DC-to-DC converter, wherein the output ripple information of the first DC-to-DC converter is acquired by the output sampling unit; and
superimposing, by the duty cycle jitter unit, the duty cycle jitter signal on a control signal of the pre-regulator controller to generate a second driving signal;
wherein the duty cycle jitter signal and the phase jitter signal have the same frequency and the same or opposite phases, and an amplitude of the duty cycle jitter signal is determined based on the output ripple information of the first DC-to-DC converter.
